(19) United States
(12) Patent Application Publication
(10) Pub. No.: US 2025/0178926 A1
(43) Pub. Date: Jun. 5, 2025

(54) SIMULTANEOUS SALT REJECTION AND HEAT LOCALIZATION VIA ENGINEERING WICK STRUCTURE AND MACROCHANNELS IN 3D EVAPORATOR AND MANUFACTURING METHOD THEREFOR

(71) Applicant: City University of Hong Kong, Hong Kong (HK)

(72) Inventors: Jian LU, Hong Kong (HK); Zhengyi MAO, Hong Kong (HK); Yicheng HAN, Hong Kong (HK); Yingxian CHEN, Hong Kong (HK); Lanxi LI, Hong Kong (HK)

(21) Appl. No.: 18/525,917

(22) Filed: Dec. 1, 2023

(51) Int. Cl. C02F 1/14; B01D 1/00; C02F 1/04; C02F 103/08; F24S 10/80

(52) U.S. Cl. CPC C02F 1/14; B01D 1/0035; C02F 1/048; F24S 10/80; C02F 2103/08; C02F 2201/009

(57) ABSTRACT

The present invention provides a high-efficiency buoyancy-driven convection-based 3D solar evaporator designed for the simultaneous rejection of salt and stable evaporation of high salinity water. The product combines different strategies, including engineered wick structure, low tortuosity macrochannels and edge-preferential salt crystallization. As a result, this evaporator demonstrates a stable evaporation rate of at least 2.5 kg m⁻² h⁻¹ under solar irradiance of 1 kW m⁻² with sea water or salt solution of salinity of over 8 wt %.

### FIELD OF THE INVENTION

The present invention relates to an evaporator for desalination, more specifically with a particularly engineered 3D wick structure and macrochannels to allow simultaneous salt rejection and heat localization.

### BACKGROUND

Clean water has always been essential to human well-being. However, multiple factors including population growth, urbanization, industrialization and climate change have contributed to water scarcity. As such, in addressing the global challenges associated with water scarcity and the growing demand for freshwater, solar desalination is an increasingly popular and crucial solution.

Solar desalination has multiple advantages over other desalination technologies. It opens up vast water resources from the sea, previously untappable for drinking water and agricultural irrigation, and is thus particularly effective in mitigating freshwater shortage situations in regions where seawater is abundant. Also, solar desalination enables regions to be less dependent on traditional freshwater sources (i.e. rivers and lakes) which are otherwise susceptible to environmental pressures including over-extraction and pollution. The operability of solar desalination systems off-grid promotes application for remote or disaster-stricken areas weakened or no power infrastructure. Solar desalination is powered by sunlight, therefore the technology is intrinsically sustainable and thus environmentally friendly.

Among the desalination technologies, interfacial solar water evaporation is considered one of the most sustainable options. Taking advantage of the solar energy to induce phase change of liquid water into vapor, not only is interfacial solar water evaporation efficient with high recovery rates, but it is also sustainable and has zero carbon footprint. Also, this technology is scalable and adaptable, thereby allowing off-grid application. The interfacial solar water evaporation systems are, in general, relatively simple and cost-effective to implement, without any dependence on complex infrastructure. Among the solar evaporators, 3D evaporator is emerging as a promising design, as it can capture additional energy from the surroundings and contribute greatly to the evaporation, yielding an evaporation rate that exceeds the theoretical value of 1.45 kg m⁻²h⁻¹.

However, beyond the evaporation rate, the challenge of salt-fouling has gained more and more attention. Due to the slow diffusivity of salt in water (˜10⁻⁹ m² s⁻¹), there is significant salt accumulation during continuously operation. The accumulated salt not only seriously compromises sunlight absorption, but also blocks water transport channels, deteriorating evaporation performance and ultimately leading to system failure.

Recent innovative strategies to achieve long-term solar desalination can be classified into three general categories.

The first category is designs which aim to separate the solar absorber and salt water (e.g. contactless evaporation and Janus structure). These designs prevent brine arrive the light absorption layer, thus avoids surface salt accumulation. However, the evaporation performance is hindered by the rapid heat loss from the photo-thermal layer to the environment or bulk water, leading to a low energy convection efficiency.

The second category is designs which aim to localize salt crystallization. A 2D evaporator with edge-preferential crystallization by adjusting the brine transportation pathway is reported. Despite the excellent salt rejection capability, its evaporation rate is relatively low (˜1.4 kg m⁻² h⁻¹).

The third category is designs which utilize convective flow intensified salt transfer. Engineering high through macrochannels in the wick structure to enhance the fluid convection is believed to be the simplest way to achieve salt rejection. By inducing low tortuosity macrochannels in the wick structure to bridge the high salt region and bulk water, it becomes possible to enable a stronger water supply and faster transportation of salt ions (FIG. 1A). However, the fluid exchange between the high salt region and the bulk water not only removes salt but also causes significant heat loss (ΔT₁) and low evaporation rate, due to the coincidence of the high temperature (T₁) and high salt zone.

Thus, there is a need to improve the interfacial solar desalination systems to achieve capability of simultaneous salt rejection and heat localization to maintain high evaporation performance and prevent salt fouling. The present invention addresses this need.

### SUMMARY OF THE INVENTION

Addressing the above technical insufficiencies, the present invention provides a high-efficiency buoyancy-driven convection-based 3D solar evaporator designed for the simultaneous rejection of salt and stable evaporation of high salinity water. The product combines different strategies, including engineered wick structure, low tortuosity macrochannels and edge-preferential salt crystallization. As a result, the system of the current invention achieves high evaporation efficiency with good salt rejection.

In one aspect, the present invention provides a high-efficiency buoyancy-driven convection based 3D solar evaporator for simultaneous salt rejection and stable evaporation of high salinity water. The evaporator comprises an interconnected porous matrix and a photothermal material. The 3D structure of the evaporator comprises a funnel-shaped structure and microchannels on the outer surface. This evaporator demonstrates a stable evaporation rate of at least 2.5 kg m⁻² h⁻¹ under solar irradiance of 1 kW m⁻² with sea water or salt solution of salinity of over 8 wt %.

The interconnected porous structure of the evaporator comprises polyurethane, cellulose, alginate, polyvinyl alcohol, polyacrylamide or any mixture thereof.

The photothermal material of the evaporator may be selected from carbon nanotube, carbon black, carbon nanodots, graphene or any mixture thereof.

The macrochannels of the evaporator have low tortuosity and high throughput. Further, the average size of these macrochannels is approximately 500-1200 μm.

The 3D solar evaporator demonstrates high water affinity and water transport capabilities. It is capable of absorbing 750 μL water in less than 0.2 s, and transporting water to 20 mm height in less than 50 s.

The 3D solar evaporator also has a high light absorption of at least 97%.

The temperature difference between the high salt zone and the bulk water is less than 8° C. in the 3D solar evaporator.

In a further aspect, a method of making the 3D solar evaporator is provided. The method includes providing a first porous matrix and a second photothermal material respectively, and mixing of the two to form a third aqueous mixture. The method further includes pouring the third mixture into a 3D printed silicone mold and freeze at a temperature of −70° C. to −90° C.; and freeze-dry to remove the ice crystals. As such, the engineered wick structure with macrochannels of average size 500-1200 μm is formed.

The first porous matrix may be selected from polyurethane, cellulose, alginate, polyvinyl alcohol, polyacrylamide or a mixture thereof.

The second photothermal material may be selected from carbon nanotube, carbon black, carbon nanodots, graphene or a mixture thereof.

### BRIEF DESCRIPTION OF THE DRAWINGS

In the following detailed description, reference is made to the accompanying figures, depicting exemplary, non-limiting and non-exhaustive embodiments of the invention. So that the manner in which the above recited features of the present invention can be understood in detail, a more particular description of the invention, briefly summarized above, can be had by reference to the embodiments, some of which are illustrated in the appended figures. It should be noted, however, that the figures illustrate only typical embodiments of this invention and are therefore not to be considered limiting of its scope, for the invention can admit to other equally effective embodiments.

FIG. 1A display the schematics of heat localization and salt rejection in conventional convection-based evaporator (left) and the evaporator of the present invention (middle) respectively; and a comparison of the temperature differences between the high salt zone and the bulk water (T₀) in the convectional evaporator (ΔT₁) and the evaporator of the present invention (ΔT₂) (right). T₁ and T₂ refer to the temperatures in the high salt zones of the two evaporators respectively. It is observed that in the convection-based evaporator, the zones of high temperature and high salt concentration consistently overlap, resulting in significant heat loss during salt convection through the microchannels. However, in the evaporator of the present invention, the high-temperature and high-salt regions are segregated, where the interior surface is hot and the outer surface and edges are cold. Salt crystallization is localized at the edges; while the microchannels on the cold side convect salt from the high-salt zone with high efficiency and minimal heat loss. FIG. 1B shows the SEM images, where the inset is the optical image of the evaporator of the present invention; and the right image shows the polyurethane skeleton. FIG. 1C shows the water transport in the 3D transport (height=2 cm).

FIG. 2A illustrates the salt crystallization on flat sample (left), localized salt crystallization on a 3D evaporator without macrochannels (middle) and localized salt crystallization on a 3D evaporator with microchannels (right) respectively. FIG. 2B shows the structure of flat and 3D evaporators. FIGS. 2C and 2D shows the experimental and simulation results of salt crystallization on flat sample and 3D evaporator. FIG. 2E shows the simulated salt transport pathways of the 3D evaporator.

FIG. 2F illustrates the structures of 3D evaporators with 2, 3, 4 and 8 macrochannels respectfully. FIGS. 2G and 2H show the experimental and simulation results of salt crystallization on the evaporators in FIG. 2F. FIG. 2I shows the simulated salt transport pathway of the 3D evaporator with 2 macrochannels. FIG. 2J shows the harvested crystals from 3D evaporators with different numbers of macrochannels after 24 h evaporation in 10 wt % NaCl solution.

FIG. 3A shows the enhanced light trapping and evaporative surface of the 3D evaporator. FIG. 3B shows the light absorption of the 3D evaporators with different heights. FIG. 3C shows the evaporative surface areas of different evaporators. FIG. 3D shows the evaporation rates of the evaporators. FIG. 3E shows the infra-red images of different evaporators under 1 sun illumination (1 kW m⁻²). FIG. 3F shows the outer and inner surface temperatures of the evaporators in FIG. 3E. FIG. 3G shows the IR images of the 3D evaporators with no macrochannels and 8 macrochannels after 4 h illumination under 1 sun respectively. FIG. 3H illustrates the temperature variation at different positions of the evaporation system during the 4 h evaporation.

FIGS. 4A and 4B show the optical images and evaporation rates of the flat evaporator, 3D evaporator and 3D evaporator with 4 macrochannels during the 24 h continuous operation respectively. FIG. 4C shows the evaporation rate variation during the 7 days cyclic evaporation test, with the inset being optical images of the 3D evaporator with 12 macrochannels during the cyclic test. FIG. 4D illustrates the variation of the salinity of the bulk water underneath the evaporator during the cyclic experiment. All samples are prepared with height of 10 mm.

FIG. 5A shows the optical images of the 3D evaporator and 3D evaporator with 12 macrochannels during the 24 h operation in highly concentrated seawater (10.4 wt % salinity). FIG. 5B shows detailed optical images of the 3D evaporator with 12 macrochannels. FIG. 5C illustrates the evaporation rate of the 3D evaporator and 3D evaporator with 12 macrochannels accordingly. FIGS. 5D and 5E are schematic illustrations and SEM images of accumulated salt crystals from pure NaCl solution and concentrated seawater respectively. FIG. 5F shows SEM images of the salt crystals form concentrated seawater and the corresponding distribution of ions (NaCl crystals, CaSO₄ crystals and MgSO₄).

FIG. 6A is a schematic diagram of the water collection device for outdoor test. FIG. 6B shows the optical images of the device at different time points in the outdoor test. FIG. 6C shows the real-time variations of solar flux, outdoor temperature and humidity during the outdoor test. FIG. 6D is a comparison of the ion concentrations of seawater and collected water.

FIG. 7 is a schematic diagram of the preparation process of the evaporator of the present invention.

FIG. 8 shows the contact angle of the prepared polyurethane/carbon black evaporator. The contact angle is approximately 0°, and the volume of the droplet is 800 μL.

FIG. 9 shows the mechanical performance of the evaporator. The right part shows the optical images of the materials before and after 100 cyclic compressions.

FIG. 10 are schematic diagram and photo image depicting the insertion of evaporation into an EPS foam. In this configuration, water can be pumped from the hole in the foam through capillary force. The foam was cut with a custom cutter to have the same diameter as the container, in order to minimize evaporation from the gap between the foam and the container.

FIG. 11 shows the detailed structures of the flat evaporator (left), 3D evaporator (middle) and 3D evaporator with macrochannels (right) respectively. The units in the diagram are mm.

FIG. 12 shows the simulated salt transport pathways of the flat evaporator.

FIG. 13 illustrates buoyancy-driven natural convection in macrochannels through simulated velocity fields for the salt flow inside the wick structure and macrochannels for top concentrations of 3.5 wt % (left) and 15 wt % (right) respectively. Under top concentration of 15 wt %, buoyancy-driven natural convection was triggered by the salt gradient, which accelerated the reflow of the salt ions back to the bulk water.

FIG. 14 depicts the Pelect number in wick structure and macrochannels. The wick structure shows diffusion-dominated salt transportation (Pₑ<1), while the microchannel shows convection flow-dominated salt transportation (Pₑ>>1). This result demonstrates that convective flow within the macrochannels significantly contributes to the rapid reflow of salt.

FIG. 15 is a comparative illustration of the structure designs of the evaporators with different heights. To ensure consistent testing conditions, the distances between the top surface of each evaporator and the light source was maintained at the same level.

FIG. 16 shows a comparison of materials consumed for flat and 3D evaporators with the same height.

FIG. 17 are differential scanning calorimetry (DSC) curves of pure water and the water in the evaporator. The measured evaporation enthalpy of pure water and water in evaporator are 2475 J/g and 1517 J/g respectively. The water evaporation enthalpy of the water in the evaporator is much smaller than that of pure water, due to the influence of polymer network on the evaporation process.

FIG. 18 illustrates the evaporation-induced cooling effect at the edge and outer surface of the evaporator.

FIG. 19 shows the evaporation rate of the 3D evaporators with different numbers of macrochannels.

FIG. 20A illustrates the 3D evaporator with one section containing 6 macrochannels and another without any macrochannels. FIG. 20B shows the height of the seawater before and after 150 h of continuous evaporation. FIG. 20C are optical images of the evaporator after operation.

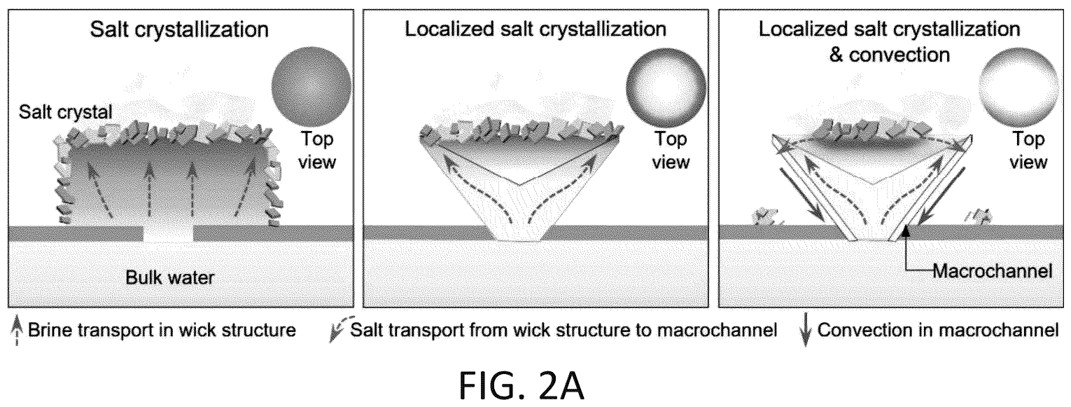

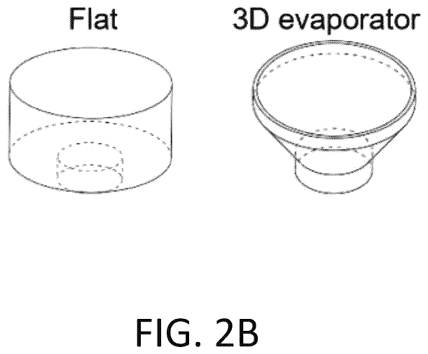

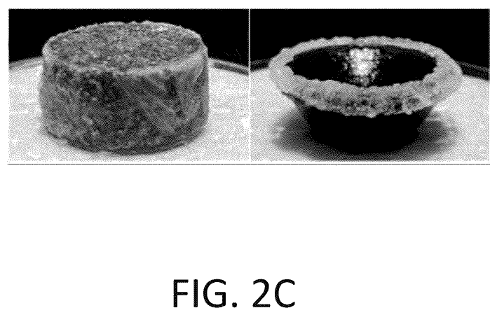

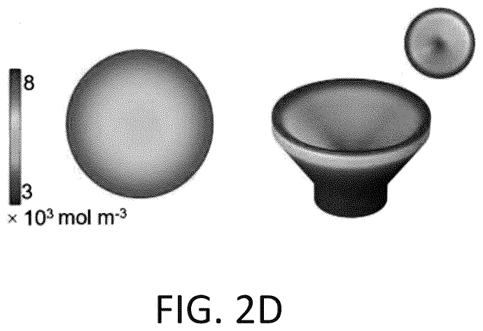

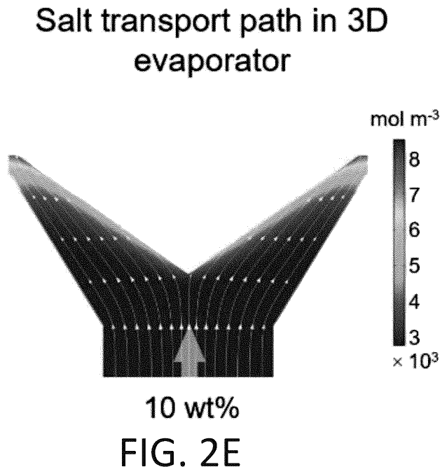

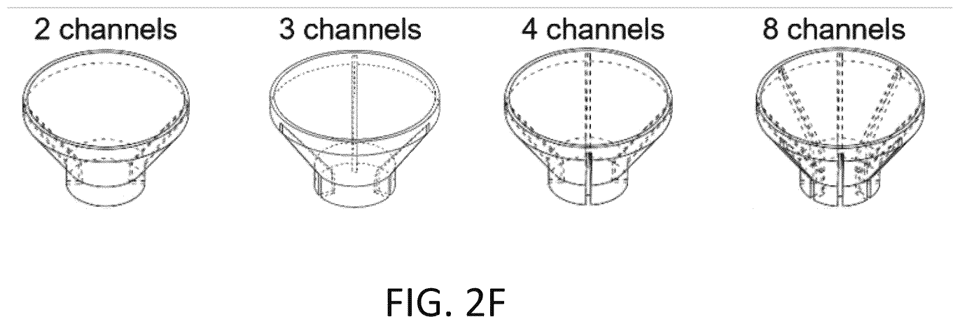

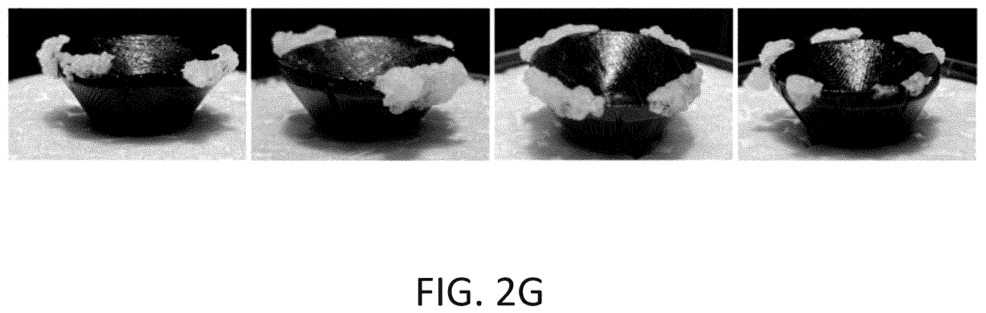

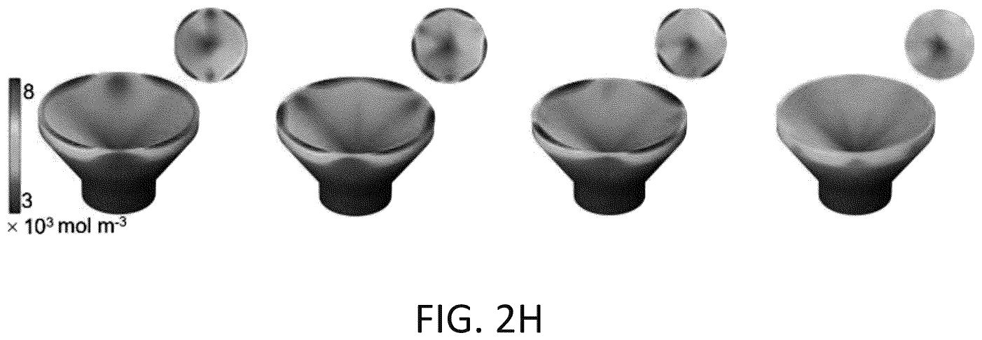

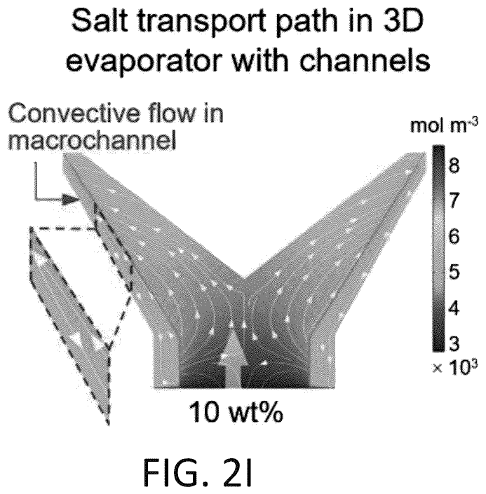

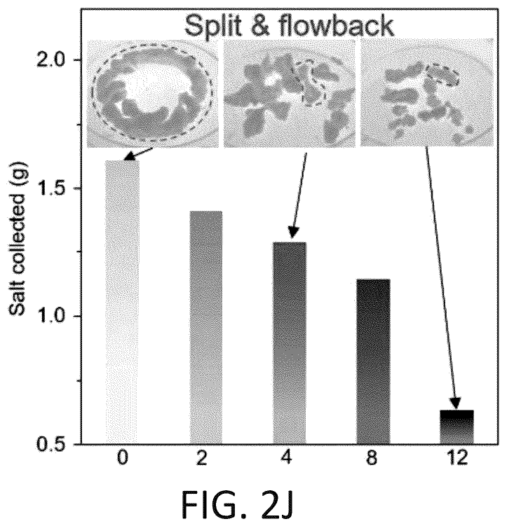

FIG. 2I show detailed optical images of the evaporator and the system during 150 h operation. 110 mL seawater was nearly fully evaporated after the continuously illumination. The section without macrochannels (right view) was fully covered by dense salt crust, which prevents light absorption and vapor generation. However, the section with macrochannels (left view) shows a localized salt crystallization. The fast convective flow in macrochannel enables the salt fast backflow to the bulk water, avoiding salt precipitated on the main surface.

### DETAILED DESCRIPTION

The present invention discloses a high-efficiency buoyancy-driven convection-based 3D solar evaporator designed for the simultaneous rejection of salt and stable evaporation of high salinity water. The evaporator comprises an interconnected porous matrix and a photothermal material, and features a unique funnel-shaped structure with macrochannels on its outer surface. The macrochannels serve as a bridge between the bulk water and the high salt zone, which initiates buoyant flow due to salt gradient and thereby allowing rapid reflow of the salt to the bulk water.

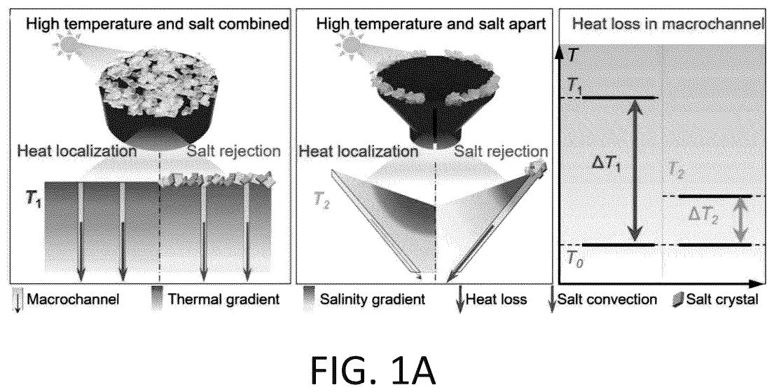

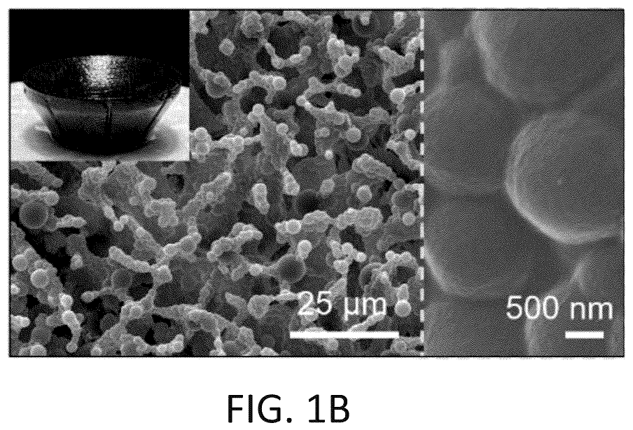

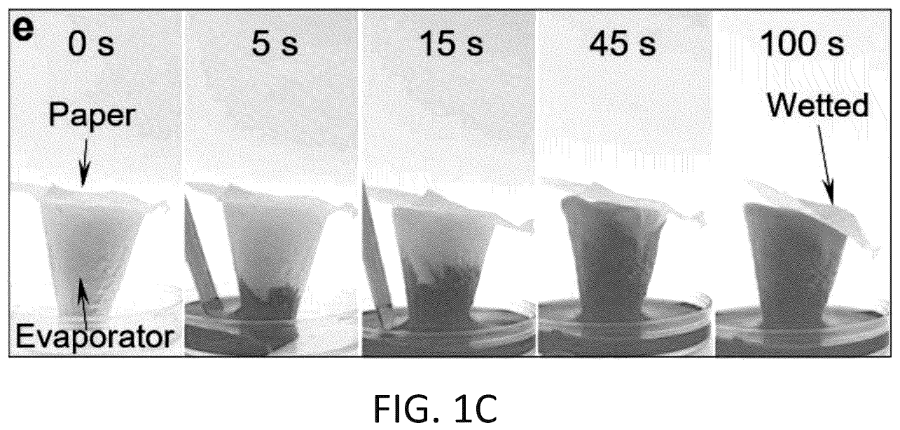

Meanwhile, the high-salt and high-temperature zones in the present invention are isolated from each other, which suppresses convective energy loss. As the inner surface is high-temperature and outer shell and edges being low-temperature, the temperature difference between the buoyant flow and bulk water would be lower than conventional convective evaporators (FIG. 1A). As such, in the present design, during convective salt rejection, energy loss is significantly reduced.

With the above distinct features, the 3D solar evaporator of the present invention displays a remarkable evaporation rate of at least 2.5 kg m⁻² h⁻¹ under solar irradiance of 1 kW m⁻². Crucially, the evaporator demonstrates good stability in evaporation when processing salt solutions or natural seawater with a salt concentration of at least 8 wt %, demonstrating its significant potential for use in practical brine desalination.

### EXAMPLES

### Example 1

### Design and Characterization of the Evaporator

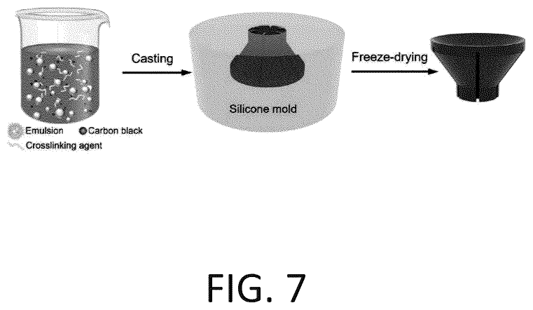

To prepare the evaporator, readily available freeze-dried polyurethane (PU) and carbon black were selected as the porous matrix and photothermal materials, respectively. The self-prepared PU sponge shows excellent water absorbing speed, mechanical durability and low cost, which are crucial for practical applications. The preparation process is shown in FIG. 7. PU emulsion and crosslinker were first mixed with deionized (DI) water at volumetric ratio of 1:0.05:1.5. Then, 1 wt % carbon black was added to the mixture, and the as-prepared solutions were poured into customized 3D-printed silica molds and frozen at −80° C. for 24 h and then freeze-dried at −50° C. for 48 h to obtain highly interconnected evaporator.

After freeze-drying to remove the ice crystals, the porous 3D evaporator with 800 μm macrochannels at the outer surface was obtained (FIG. 1). The evaporator exhibits a highly interconnected porous structure, which facilitates light trapping and water transportation.

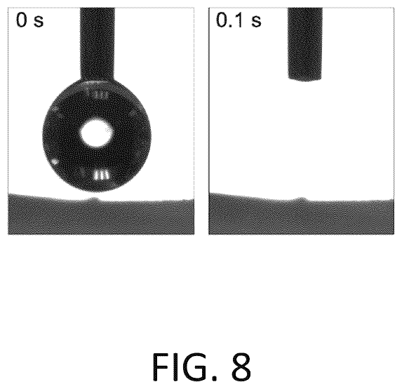

The blended PU skeleton was observed, providing the evaporator with mechanical durability. The prepared evaporator can rapidly absorb an 800 μL water droplet within 0.1 s due to its high affinity for water (FIG. 8). Moreover, it can pump water to 20 mm height in 45 s and fully wet the top paper, demonstrating its strong capillary force for water transfer (FIG. 1C).

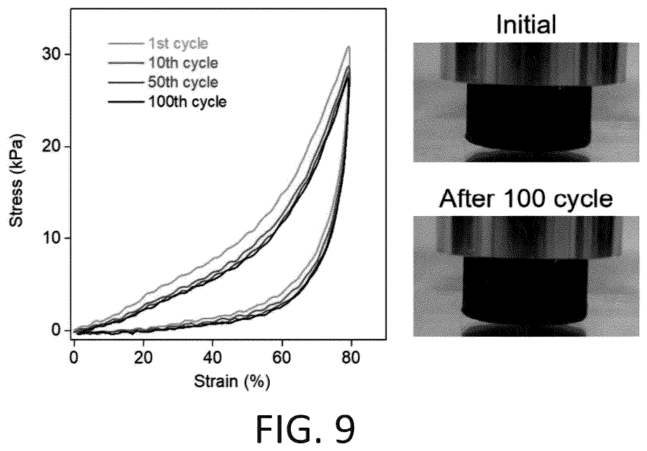

The mechanical durability is proven by cyclic compression tests. The compression tests were conducted using a mechanical testing device (Cellscale, Canada) in water. A cuboid evaporator with a length of 20 mm and a height of 8 mm was prepared. The strain rate was set as 1 mm s−1, and the compression/recovery process was conducted 100 times. After 100 compressions of 80% strain, the PU/carbon black sponge can recovery to its original size without deteriorating (FIG. 9).

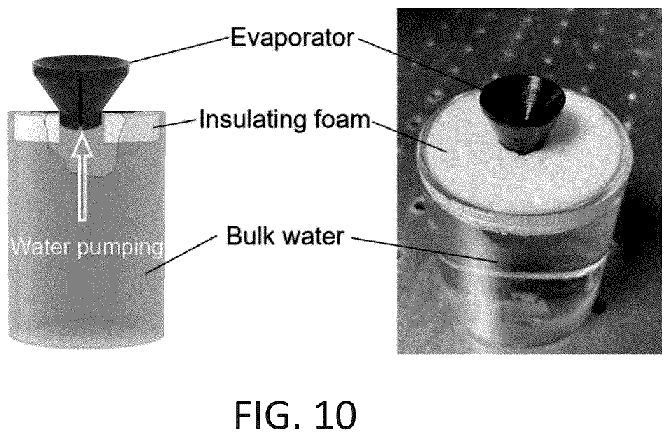

To measure the salt rejection and evaporation performance of the evaporator, the evaporator was inserted into an EPS foam for floating (FIG. 10).

### Localized Salt Crystallization and Convection-Induced Salt Rejection

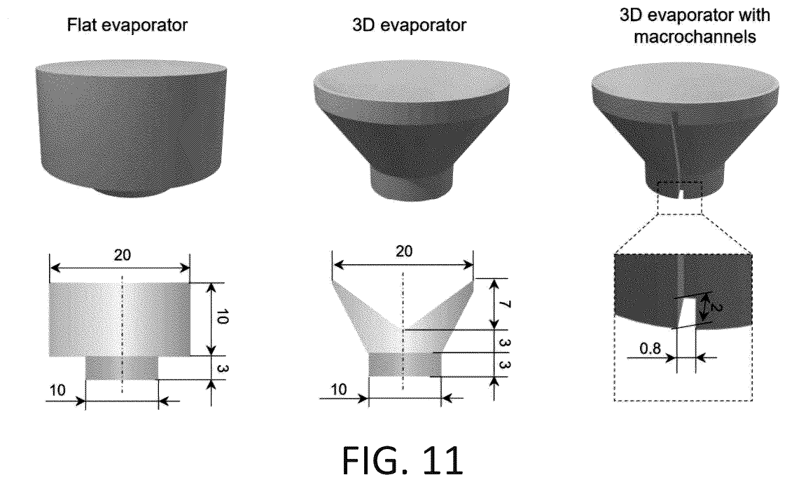

To elucidate the controllable salt crystallization of the design, 3 types of samples were prepared, including the flat evaporator, 3D evaporator, and 3D evaporator with different number of macrochannels. The detailed design of the 3 different types of samples were shown in FIG. 11.

FIG. 2A shows the mechanism of the salt crystallization of the prepared evaporators. The highly interconnected porous media drives brine transport due to capillary penetration, where the wick structure significantly affects capillary flow patterns. For instance, the flat evaporator passively absorbs brine from the bulk water reservoir and transports it to the evaporative surface. On the surface, continuous evaporation increases the salt concentration, resulting in salt crystallization and accumulation (FIG. 2A). In comparison, the structure design of the 3D evaporator enables preferential salt transport from the center to the edge. With ongoing evaporation, the concentration on the edge increases steadily, leading to edge-preferential salt crystallization (FIG. 2A). The macrochannel on the outer surface of the 3D evaporator is designed subsequently to connect the high salt zone with the bulk water (FIG. 2A). The salinity gradient between the high salt zone and the bulk water can passively trigger natural convection in the macrochannels, resulting in the reflow and splitting of the precipitated salt crystals. In addition, the adequate water supply induced by the macrochannel weakens the binding force between the split salt crystals and the evaporator. Consequently, salt particles that are suspended at the edge will spontaneously detach due to gravity, providing an opportunity to harvest valuable mineral resources from the desalination process.

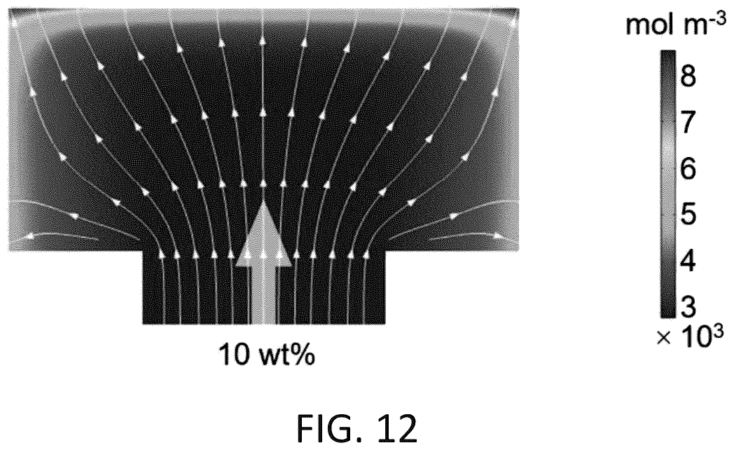

FIGS. 2B, 2C and 2D shows the experimental and simulation results of the flat and 3D evaporators after 4 h evaporation in 10 wt % NaCl solution under 1 sun. The salt precipitated on the whole evaporation surface of the flat sample, which turns it from black to white. In comparison, the salt only precipitated on the edge of the 3D evaporator, demonstrating the successfully achieve of the localized salt crystallization. The experimental results agree well with the simulation results (FIG. 2E), demonstrating the salt crystallization can be precisely predicted by computation method. FIG. 2H and 12 present the simulated salt transport paths of the 3D evaporator and flat evaporator, respectively. Despite the salt ions convectively moving with the passive fluidic flow in both evaporators, the engineered shape of the 3D evaporator leads to an edge-preferential capillary flow, which results in localized salt accumulation at the edge of the structure.

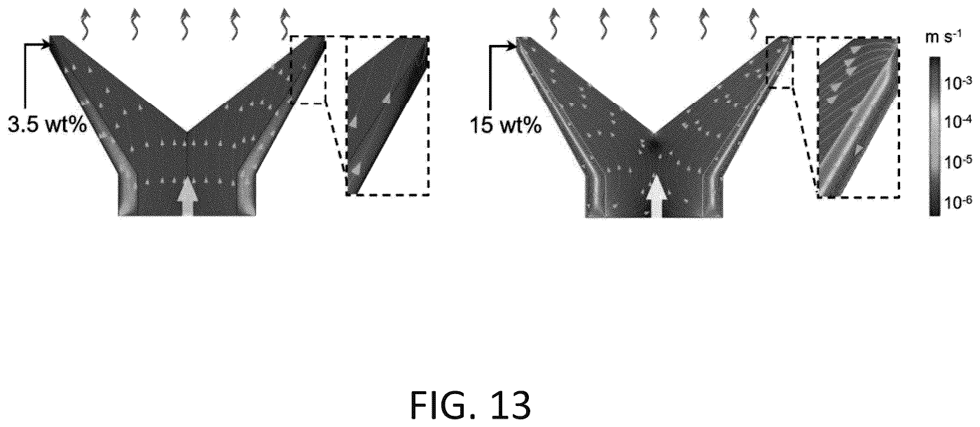

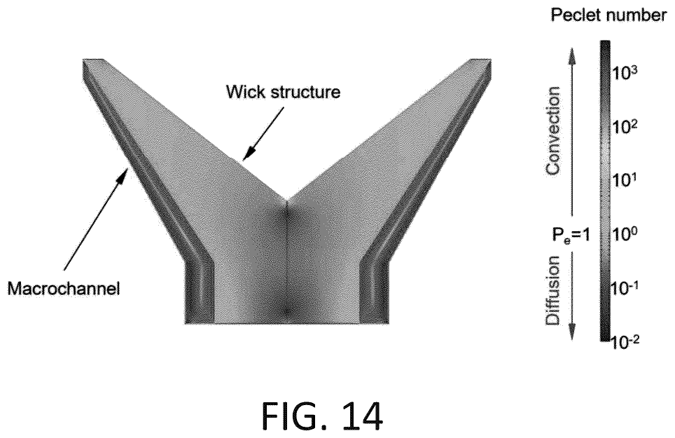

To demonstrate the effect of the macrochannel on fluid splitting and convection, four 3D evaporators with 2, 3, 4, and 8 macrochannels arranged in a circular array on their outer surfaces were prepared (FIG. 2E). FIGS. 2F and 2G display the precipitated salt crystals obtained from both experimental and simulated evaporation processes. In comparison to the 3D evaporator without macrochannel in FIG. 2B, the circular-shaped salt crystal region is split into several parts due to the presence of the macrochannels. With increasing the number of the macrochannels from 2 to 8, the simulated area reaching the salt saturation point on the surface decreases, demonstrating the localized salt rejection by the macrochannels. FIG. 2I shows the salt transport path under the influence of macrochannels, revealing that the buoyancy-driven convection rapidly reflow the salt from the region with higher salt concentration to the bulk water. Note that this buoyancy-driven natural convection results from density variations salinity increases (FIG. 13). The brine with higher salinity downstream flows downward with gravity, bringing salt ions down to the bulk water. To characterize the contribution with respect to convection and diffusion, the Peclet number is employed as the ratio between convective transport rate and diffusive transport rate, indicating that the convective transport dominates in the macrochannels (see FIG. 14). Consequently, the accumulated salts reflow into the macrochannels in a convective manner, resulting in significantly improved salt rejection capability. Moreover, the sufficient water supply by the channels weakens the binding force of the salt crystal and the evaporator, which can cause the salt crystals to drop from the edge of the evaporator. The salt crystals that were collected after a continuous 24 h evaporation process provide further evidence of the split and rejection phenomenon caused by the macrochannels. It was observed that both the size and weight of the collected salt crystals decreased as the number of macrochannels increased (FIG. 2J).

### Modelling of Salt Transport in the Macrochannel.

A multi-physics fluid flow model was developed to understand the salt transportation process in 3D evaporators:

$$\frac{\partial }{\partial t} ( ε ρ ) + ∇ \cdot ( ρ u ) = 0 \qquad ( 1 )$$

$$( 2 )$$

$$ρ \frac{\partial u}{\partial t} = - ∇ p + ∇ \cdot \{ \frac{μ}{ε} [ ∇ u + {( ∇ u )}^{T} - \frac{2}{3} ( ∇ \cdot u ) I ] \} - \frac{μ}{κ} u + ρ g [ 1 - α ( T - {T}_{∞} ) ]$$

The salt transport of dilute species, laminar fluid flow and heat transfer of evaporators were studied through COMSOL 6.5. The continuity, momentum, energy and advection equations were coupled and numerically solved by the finite element method (FEM). Here, different porosities were employed to distinguish the wick domain (ε=0.7) and macrochannels (ε=1) according to experimental characterization. Both wick and macrochannels were filled with brine of 3.5 wt % salt concentration as the initial condition. The buoyancy-driven flow was captured by introducing the gravity effect due to concentration and temperature differences. Here, the density of brine spatially varies with concentration c, given as ρ(c)=ρ0+βc, where ρ0 denotes the density of water and β is a constant. Differently, the temperature effect was implemented by applying the Boussinesq approximation in the buoyancy term, given as ρg[1−α(T−T∞)] in the momentum conservation, where α is the thermal expansion coefficient.

FIG. 13 depicts the velocity fields of the 3D evaporator with macrochannels under different top surface concentrations. It was found that capillary penetration dominates with 3.5 wt % salt concentration at the top surface. In comparison, flow direction changes in the macrochannels as concentration increases, suggesting a significant buoyancy-driven flow occurs and capillary penetration is suppressed. It should be noted that the length scale of macrochannels is much larger than that of hydraulic pores, resulting in that gravity being sufficiently strong to dominate the fluidic behavior instead of capillary force. In addition, this buoyancy-driven flow triggers the convective salt reflow from the surface to macrochannels, significantly accelerating the salt rejection. The Peclet number quantitively depicted the ratio of contribution between convection and diffusion (see FIG. 13), given as Pe=LuD, where L, u and D denote the characteristic length, flow velocity and diffusivity, respectively.

To distinct the wick domain and macrochannels, the laminar fluidic flow is consistently governed by mass conservation and Brinkman equation with neglecting the inertial term, where ρ, u and p are density of brine, velocity vector and pressure, respectively. Gravity is induced by the gravitational constant g. The porous medium of wick is implied by porosity ε and permeability κ. In macrochannels, the viscous loss induced by porous media is avoided by reducing the Brinkman formulation to Navier-Stokes equation as ε and κ vanishes.

The temperature field and salt transportation are determined by energy conservation and convection-diffusion equation, respectively:

$$ρ {C}_{p} ( \frac{\partial T}{\partial t} + u \cdot ∇ T ) + ∇ \cdot q = 0 \qquad ( 3 )$$

$$\frac{\partial ε c}{\partial t} + u \cdot ∇ c - ∇ \cdot ε τ {D}_{L} {∇}_{c} = 0 \qquad ( 4 )$$

Note that the brine density varies with respect to the salt concentration and temperature T, initiating buoyancy-driven flows. To capture these natural convection flows, equations 3 and 4 are coupled with the fluid flow model (equations 1 and 2). In this study, energy induced by incident solar flux is applied on the top surface of the evaporator. This uniform heat flux results in the evaporation of the brine-air interface and salt accumulation accordingly. Meanwhile, the bottom surface contacting the reservoir provides a fresh water supply (brine at the salt concentration in seawater at room temperature).

### Heat Localization and Evaporation Performance

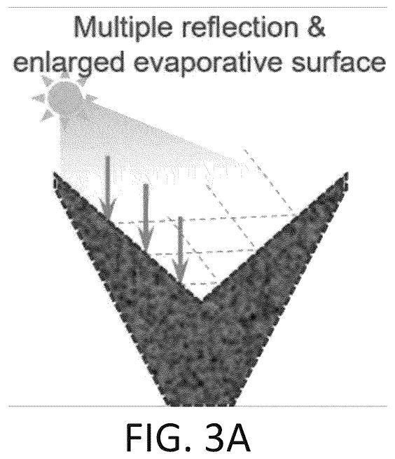

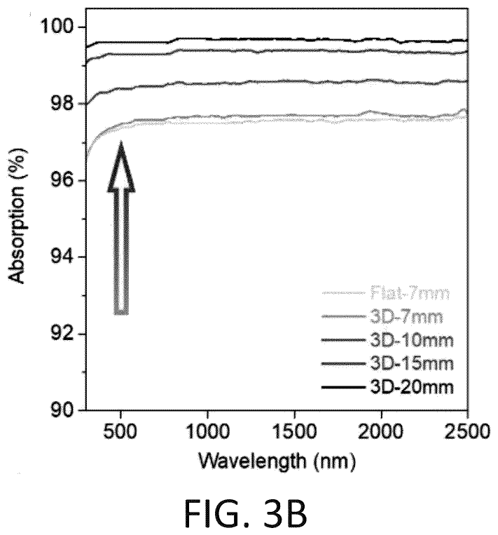

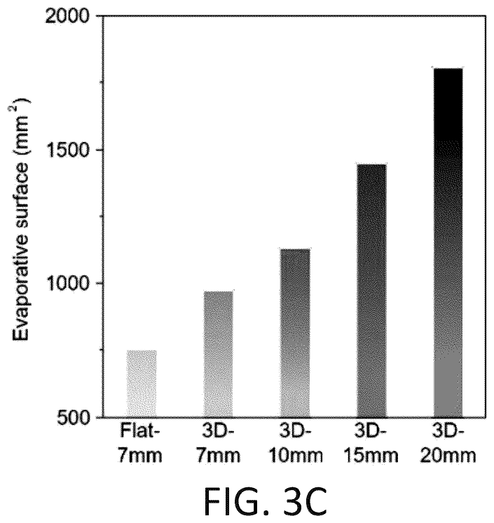

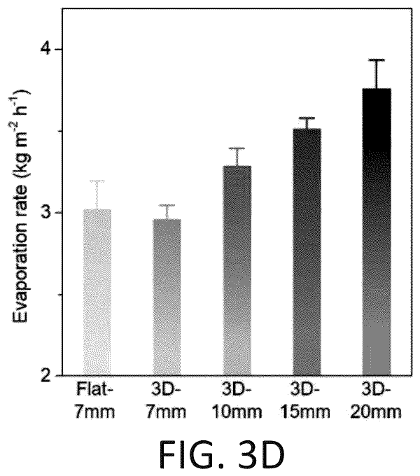

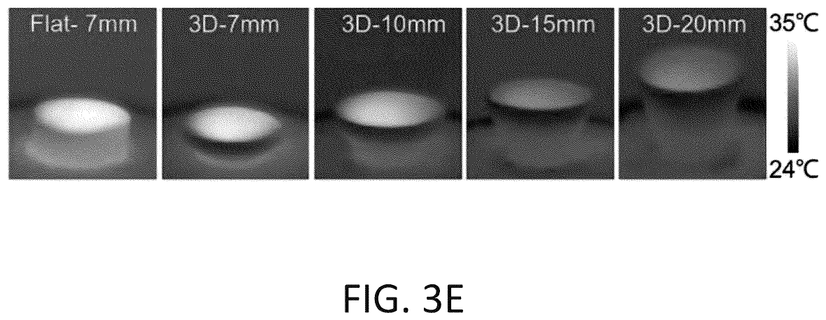

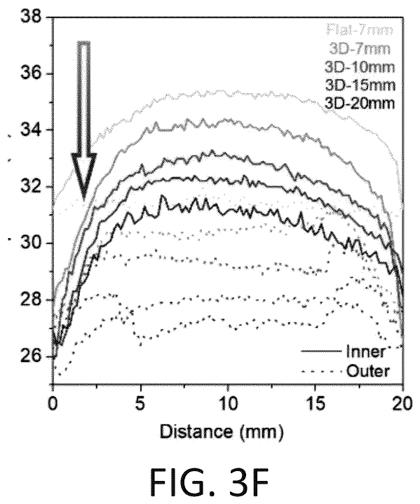

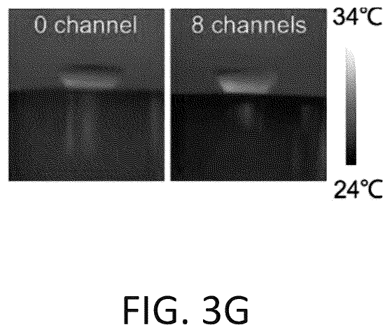

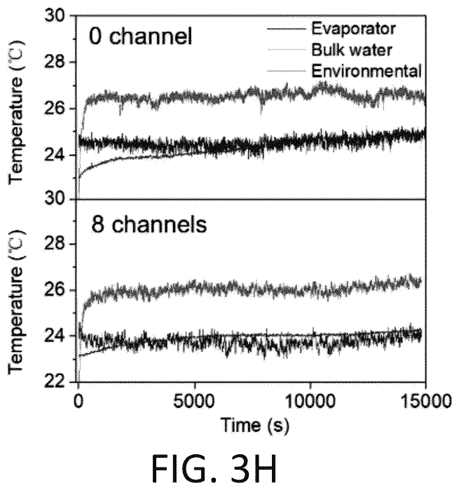

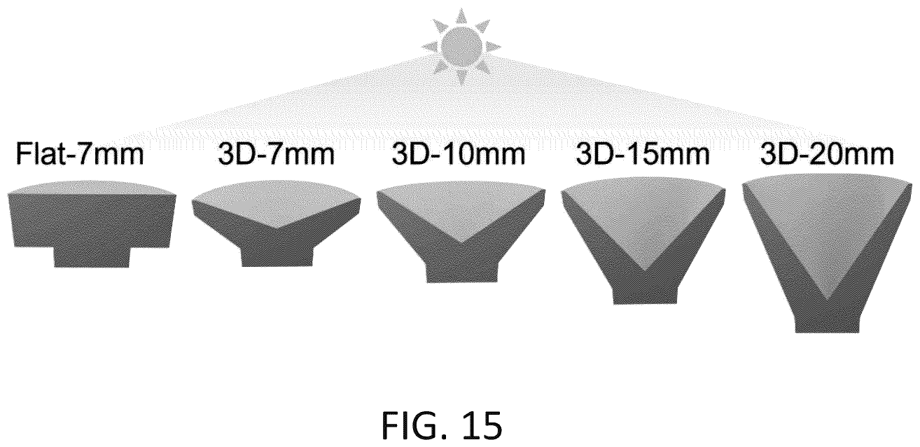

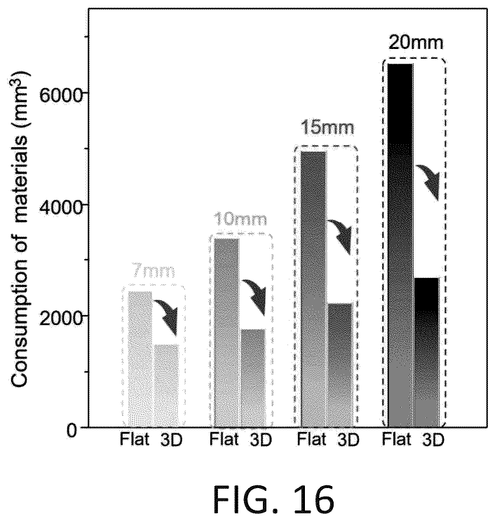

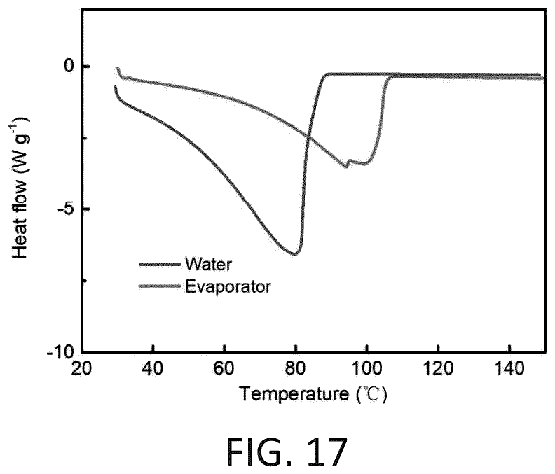

The flat evaporator with the height of 7 mm, and 3D evaporators with heights of 7, 10, 15 and 20 mm were prepared to evaluate the effect of the 3D structure on the evaporation performance and the heat localization (FIG. 15). Compared to the flat sample, the 3D structure shows better light trapping ability via the absorption of light reflected multiple times (FIG. 3A). Simultaneously, the 3D evaporators exhibit a larger air-evaporator interface for vapor generation, while using fewer materials (FIG. 16), which would benefit practical applications. The light absorption property was evaluated by the UV-Vis-NIR absorption spectra in the range of 250-2500 nm (FIG. 3b). The 3D evaporator with a height of 7 mm shows a light absorption of 97.4%, which is slightly higher than that of the flat evaporator with the same height. With further increases the height of the 3D evaporator, the light absorption significantly enhanced to 99.6%, which strongly evidences the superiority of the engineered 3D structure for light trapping. In addition, the light absorbance for the 3D evaporator is also outstanding among the recently reported structured light-absorbing materials. Subsequently, the evaporative surface of different evaporators is calculated (FIG. 3C). The evaporative surface of the flat and 3D sample with same height of 7 mm are 753.6 mm² to 972.9 mm², respectively, representing a nearly 30% improvement. This enlarged surface area facilitates water molecules at the interface to gain energy and escape into the air, resulting in a high evaporation rate. The evaporation performance of as-prepared evaporators was measured under 1 sun illumination (FIG. 3d). The evaporation rate increased from ˜2.9 kg m⁻²h⁻¹ for the 7 mm sample to 3.75 kg m⁻²h⁻¹ for the 20 mm height 3D sample. This enhancement was due to the engineered 3D architecture, which endowed increased light absorption and evaporative surface area. Additionally, the reduced water evaporation enthalpy by the materials and the energy input from the environment also contributed to this excellent evaporation rate (FIG. 17).

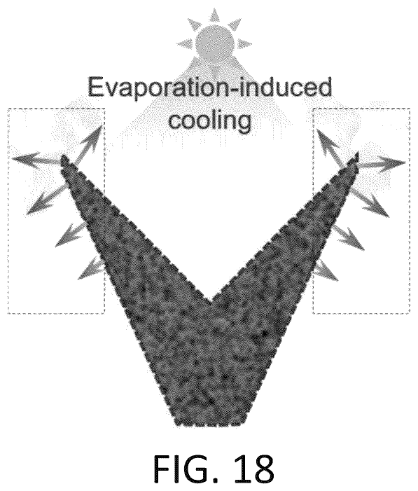

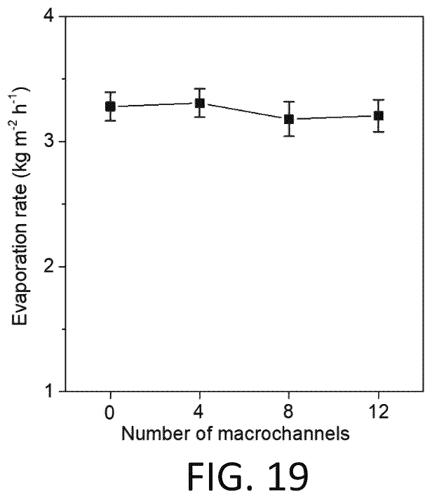

FIG. 3E illustrates the temperature distribution of the prepared evaporators. The flat evaporator exhibits a high temperature domain at its top surface, which coincides with the high salt concentration zone as depicted in FIG. 2D. Conversely, the 3D evaporator displays a distinct temperature profile with a concentrated hot zone at its inner surface, while the edge and outer surface exhibit lower temperatures. This temperature distribution results in the separation of the high temperature and salt zones within the 3D evaporator. The low temperature on the edge generates great tension, speeding up the brine transport to the edge. And according to the classical nucleation theory, heterogeneous nucleation tends to occur in a position with low temperature, which also promotes edge-preferential salt crystallization. The temperature at the high salt zone of the flat evaporator is 35.4° C., exceeding that of the 3D evaporator with the same height by 7.7° C. When the height of the 3D evaporator increased to 20 mm, the temperature at the edge and outer surface decreased to 24° C. and 26.4° C., respectively (FIG. 3F). The lower temperature observed at the edge and outer surface can be primarily attributed to the absence of direct illumination, while the evaporation-induced cooling effect further enhances the cooling (FIG. 18). The large interfacial surface at the edge of the 3D evaporator facilitates vapor escape, leading to cooling of the edge and the outer surface through latent heat and radiation simulation of the temperature distribution of the 3D evaporator yielded the same result. Thus, by reducing the temperature difference between the high salt zone and the bulk water from 10.4° C. (ΔT₁) to 1.4° C. (ΔT₂), the fluidic convection-induced heat loss through the macrochannel can be sharply diminished. The effectiveness of minimal heat loss was confirmed by monitoring the temperature of the bulk water beneath the 3D evaporator and the 3D evaporator with 8 macrochannels, respectively (FIGS. 3G and 3H). After 4 h of continuous evaporation under 1 sun, the temperature of the bulk water in both groups was almost the same as the environment temperature. This indicates that the conductive heat was confined, with only a small amount transferred to the bulk water, and the macrochannels had negligible impact on heat dissipation into the bulk water. Moreover, the evaporation rates of 3D evaporators are compared with varying numbers of macrochannels (0, 4, 8, and 12). The increase in number of macrochannels did not result in a decrease in the evaporation rate, providing further evidence of the minimal heat loss caused by the macrochannels (FIG. 19).

### Long-Term Stability

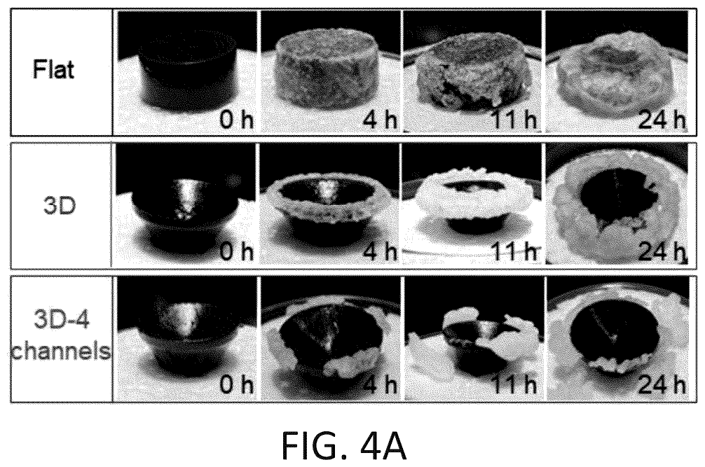

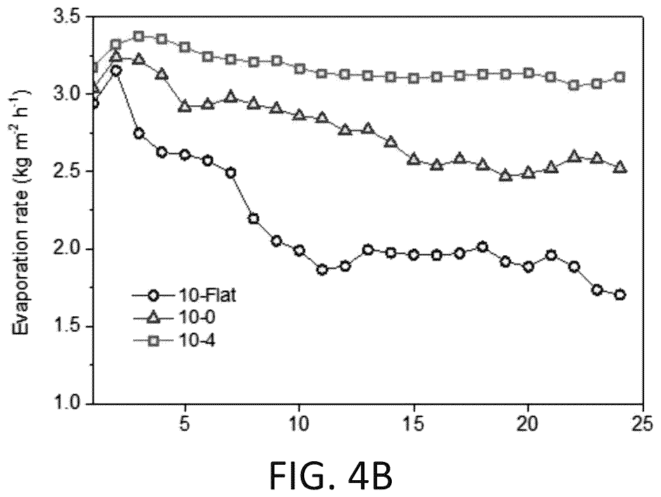

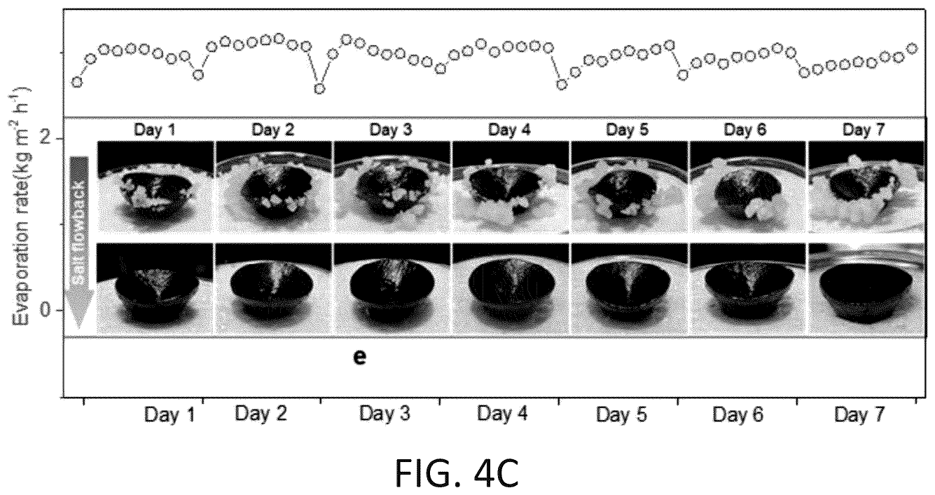

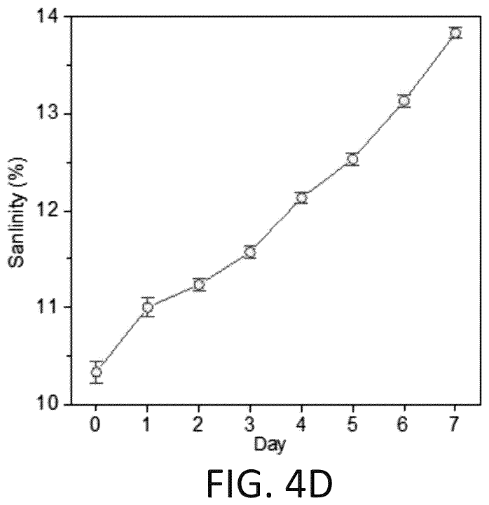

To evaluate the effect of engineered 3D wick structure and macrochannels on the salt rejection and evaporation performance, long-term evaporation tests were conducted in 10 wt % NaCl solution. After 24 h continuously operation under 1 sun, the flat evaporator became thoroughly encrusted with salt crystals (FIG. 4A). This led to a significant reduction in the rate of evaporation, dropping from 3.15 kg m⁻²h⁻¹ to 1.7 kg m⁻²h⁻¹ (FIG. 4B). For the 3D evaporator, the salt precipitated at the edge of the evaporator, causing a slight reduction in evaporator rate from 3.23 kg m⁻²h⁻¹ to 2.52 kg m⁻²h⁻¹. This demonstrates that edge-preferential salt crystallization can isolate salt from the majority of the evaporation surface, thereby avoiding the cessation of evaporation. In comparison, the salt crystal was split into 4 parts and fell off automatically under gravity for the 3D evaporator with 4 macrochannels. The evaporation rate remained steady at 3.1 kg m⁻²h⁻¹ during long-term operation. These results illustrate that the 3D structure facilitates localized salt crystallization, while the macrochannels split and convect the salt to the bulk water without inducing heat loss. A 7-day cycling experiment was conducted to further confirm the long-term stability of the evaporator. In each cycle, the evaporator was operated for 9 hours under 1 sun, simulating typical daily natural sunshine irradiation in Hong Kong. The 10 wt % NaCl solution was periodically replenished to maintain a constant distance between the evaporator and light source. During the 7-day cycling test, the evaporator rate stabilizes at approximately 3 kg m⁻²h⁻¹ without degradation (FIG. 4C). This stability is attributed to the engineered 3D structure and macrochannels, which facilitate the fast transport of salt ions and prevent salt crystals blockage of the evaporative surface. The inset in FIG. 4C shows the salt crystallization and flowback process. After being operated under 1 sun, the salt precipitated locally at the edge of the evaporator, splitting into several small parts, while some salt crystals fell off on the floating foam due to the gravity. After turning off the light, the precipitated salts were able to flowback to the bulk water, driven by the strong water supply of the highly interconnected porous structure and the macrochannel. The salinity of the NaCl solution increase from 10.3 wt % to 13.9 wt % due to the flowback of the salt ions (FIG. 4D).

### Salt Rejection in Real Concentrated Seawater

The evaporation performance in real-world concentrated seawater brine is of great significance for the field of solar desalination but rarely proposed yet. The salt rejection in highly concentrated seawater is challenging due to the complex salt crystallization behavior that occurs in natural seawater, which contains a greater variety of constituent elements than pure NaCl solution. When tested in pure NaCl solution, the water evaporation remains stable for a long period of time. However, when operating in real concentrated seawater brine, the water evaporation drops quickly. This difference can be attributed to the significant disparity in salt crust structures between pure NaCl solution and real seawater.

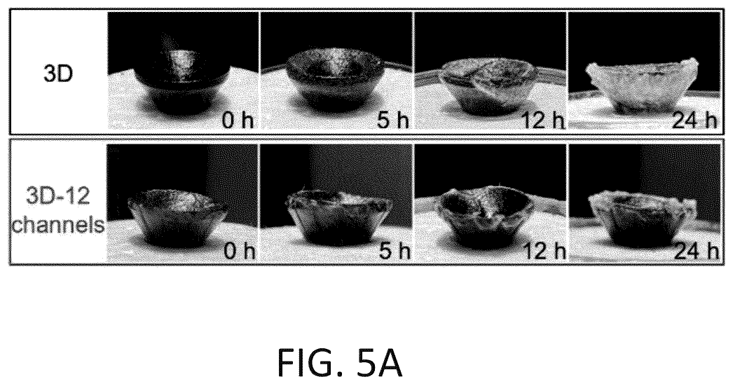

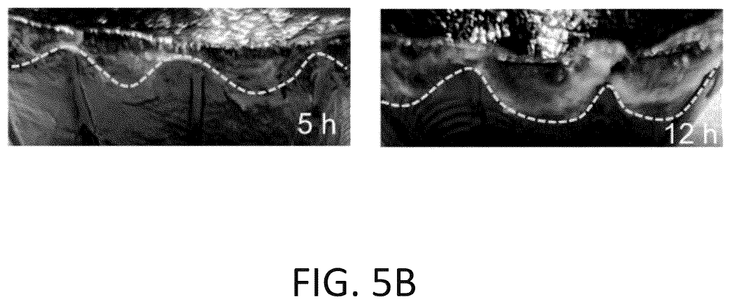

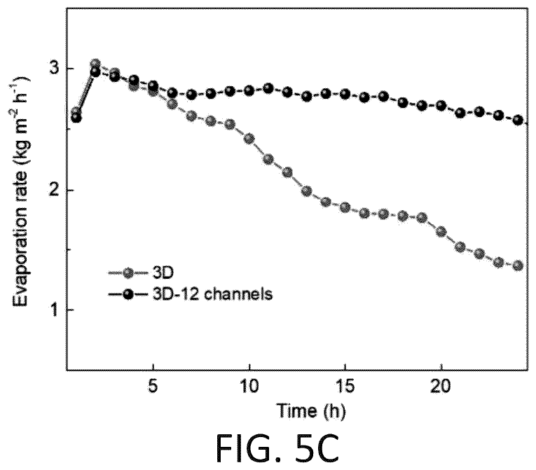

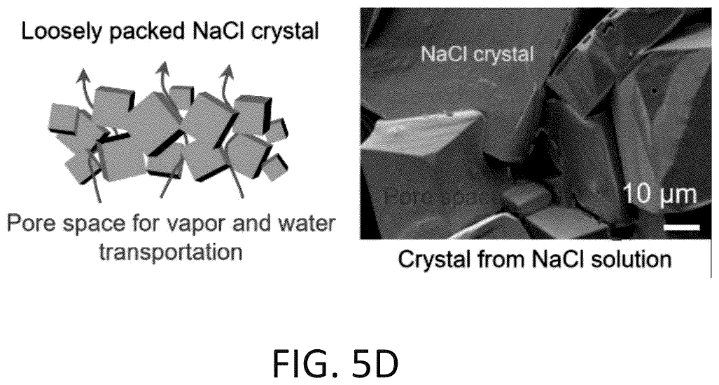

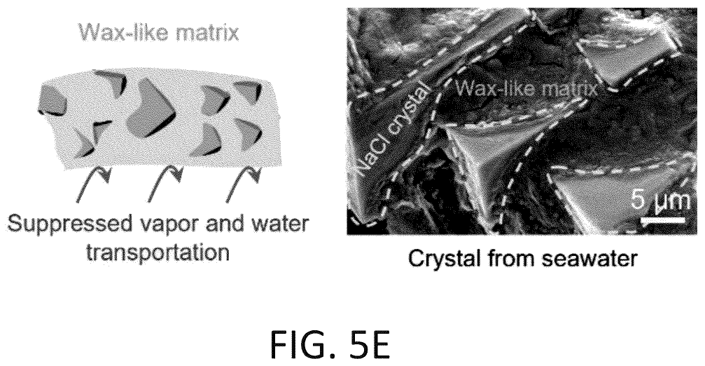

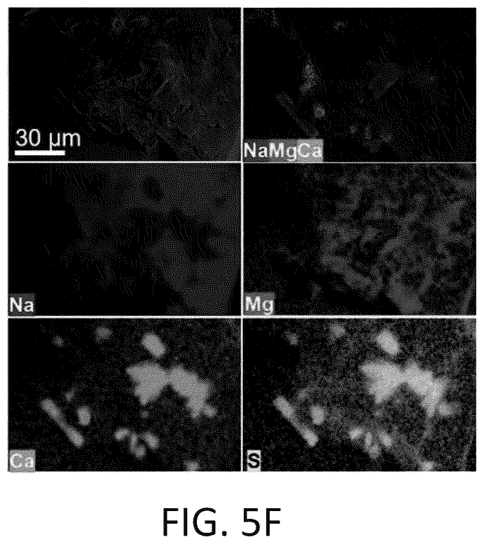

To demonstrate the practicality of the present design, a continuous operation was conducted to measure the evaporation performance of the 3D evaporator and the 3D evaporator with 12 macrochannels in highly concentrated seawater (10.4% salinity). Unlike the ring-shaped salt crust formed from the evaporation of 10 wt % pure NaCl solution, the 3D evaporator in concentrated seawater exhibited a dense salt film, ultimately covering the entire 3D evaporators (FIG. 5A). The resulting precipitation of salt crystals led to a sharp decrease in the evaporation rate by 1.67 kg m⁻²h⁻¹ (FIG. 5C), which is over 2.3 times higher than that measured pure NaCl solution in FIG. 4B (0.71 kg m⁻²h⁻¹). On the contrary, in the 3D evaporator with macrochannels, salt only precipitated at the edge and exhibited a jagged shape (FIG. 5B). The macrochannel enables the salt ions fast flow into the underlying seawater, thereby reducing salt crystallization near the macrochannels. Consequently, the evaporation rate of the 3D evaporator with 12 macrochannels remained stable during continuous operation. This demonstrates that the convection-induced salt rejection also applicable for real concentrated seawater.

In order to illustrate the difference in evaporation performance when treating pure NaCl solution versus natural seawater, salt crystals formed from both solutions with the same concentration (˜10 wt %) were investigated. FIG. 5D shows the salt crust obtained from evaporation of pure NaCl solution where the cubic salt crystals exhibit a clean surface, and the loosely packed salt permits water transport and vapor escape. However, the salt crust from the concentrated seawater shows a denser structure. In addition to the cubic NaCl crystals, some clubbed crystals were observed, and the gap space between the crystals was filled with a wax-like matrix (FIGS. 5E and 5F). EDS analysis revealed that the clubbed crystals are calcium sulfate, sparsely decorated between the NaCl crystals (FIG. 5F). Magnesium was identified in the wax-like substances, which filled the entire pore space around the NaCl and CaSO4 crystals, leading to the formation of the dense salt crust. Thus, the 3D evaporator operated in concentrated seawater was halted by the formation of the dense salt crust. However, for the 3D evaporator with macrochannels, the strong convection in the macrochannels not only allows for the backflow the NaCl but also that of calcium and magnesium ions, preventing the precipitation of dense salt crust on the main evaporation surface.

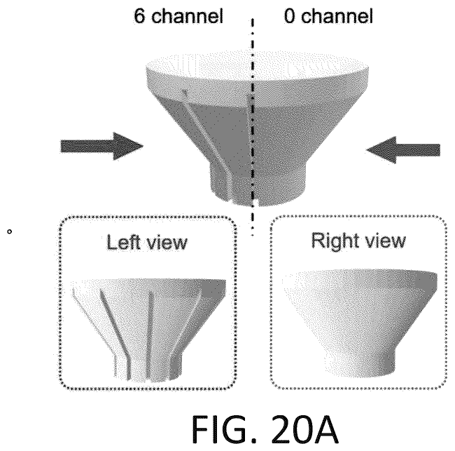

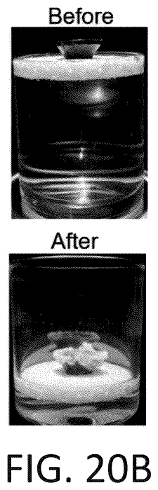

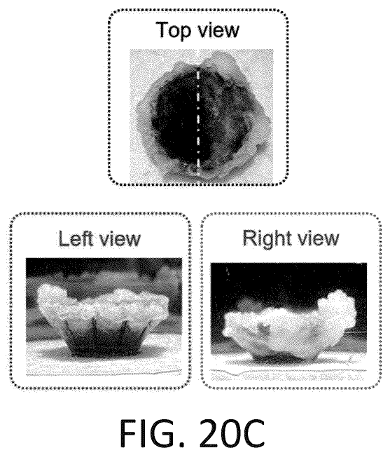

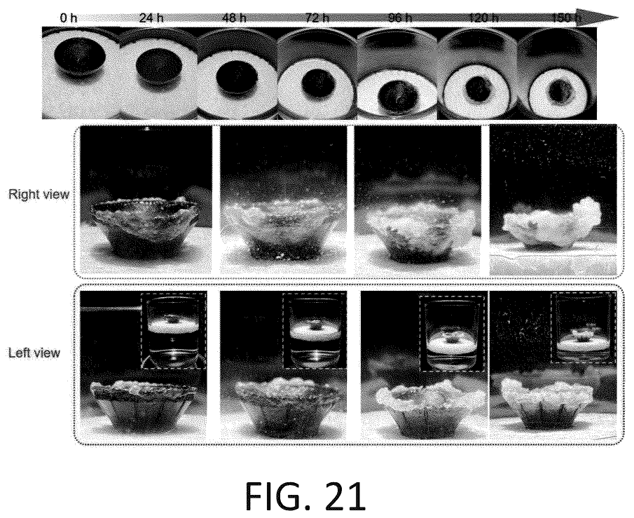

To further prove the salt rejection capability of the evaporator in real seawater, continuous evaporation of 108 mL of seawater was performed. The 3D evaporator was fabricated with one section containing 6 macrochannels and another section without any macrochannels as shown in FIG. 20A. After 150 h continuously operation under 1 sun (the equivalent of 1 kW m⁻²), the underlying seawater had nearly completely evaporated. The evaporator displays an in a symmetrical distribution of the salt crystals, where the section containing macrochannels exhibiting localized and fragmented salt crystals. Conversely, the section without macrochannels was entirely covered by the salt crystal (FIG. 20C).

### Outdoor Test of the Water Collection Device

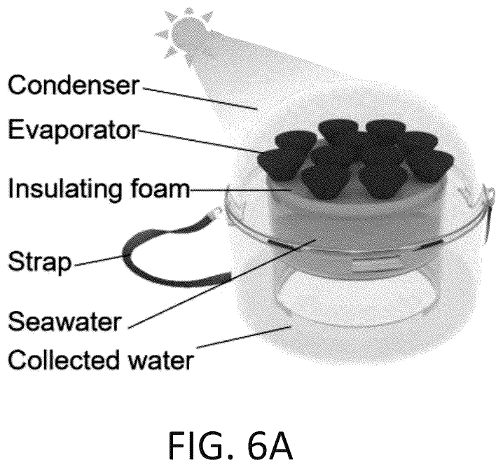

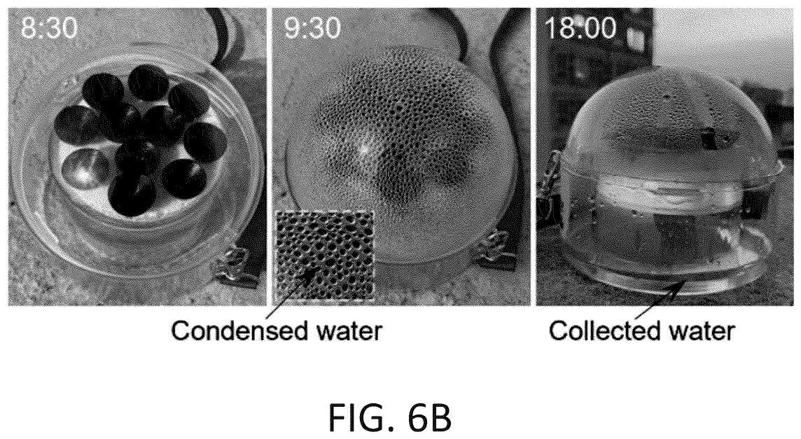

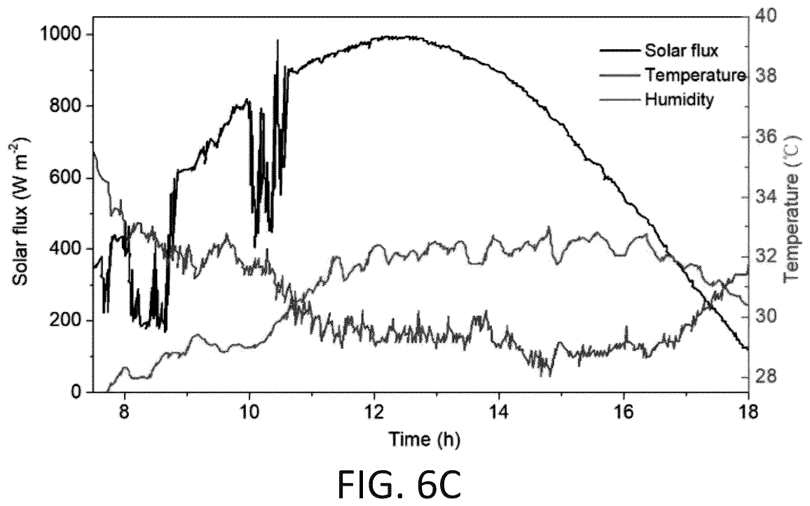

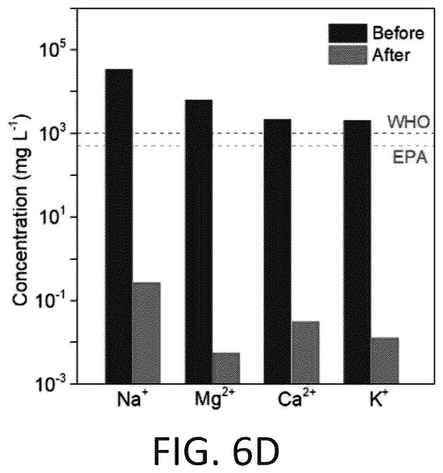

Regarding the practical implementations, the water collection performance is also an important criterion for evaluation but has been largely ignored in many previous studies on salt rejection evaporator. In this study, a portable solar water purification prototype was prepared to demonstrate its potential for practical seawater desalination (FIG. 6A). Eleven 3D evaporators, each containing 8 macrochannels, were inserted into insulation foam and floated on the seawater. The prototype was deployed on the rooftop in Sham Shui Po, and the evaluation period spanned from 8:00 to 18:00. Under natural sun irradiation, the vapor was generated and condensed at the transparent cover to form the droplets, which were eventually collected at the bottom of the device (FIG. 6B). The average sunlight fluxwas˜0.68 kW m-2 and the highest recorded outdoor temperature was 93° C. (May 29, 2023, FIG. 6C). After a one-day test, a total of 25.69 g of water was collected. Based on the evaporator area of 34.54 cm², the daily water collection rate was calculated to be 7.44 L m⁻². This freshwater productivity was superior to the previous record of the salt-rejection solar evaporators (˜2.5 L m⁻², ˜5 L m⁻²). Furthermore, over 99.9% of the ions were removed by the solar evaporation process, and the ion concentration of the purified water was lower than the requirements of WHO and EPA (FIG. 6D). Such excellent water production and purification performance satisfies the daily drinking water requirements of three individuals per square meter of the evaporator of the present invention (2 L and 2.5 L per day for females and males, respectively, as recommended by the European Food Safety Authority).

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of 10%, ±5%, ±1%, or ±0.5% of the given value or range. The range may be indicated herein as from one endpoint to another endpoint or between two endpoints. Unless otherwise specified, all the ranges disclosed in the present disclosure include endpoints. The term “substantially coplanar” may refer to two surfaces within a few micrometers (m) positioned along the same plane, for example, within 10 μm, within 5 μm, within 1 μm, or within 0.5 μm located along the same plane. When reference is made to “substantially” the same numerical value or characteristic, the term may refer to a value within ±10%, ±5%, ±1%, or ±0.5% of the average of the values.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A high-efficiency buoyancy-driven convection based 3D solar evaporator for simultaneous salt rejection and stable evaporation of high salinity water, comprising:
an interconnected porous matrix; and
a photothermal material;
wherein the 3D solar evaporator comprises a funnel-shaped structure and macrochannels on the outer surface;
wherein the evaporation rate of the 3D solar evaporator is at least 2.5 kg m⁻² h⁻¹ under solar irradiance of 1 kW m⁻²; and
wherein the evaporator is capable of stable evaporation of salt solution or natural seawater with salt concentration of at least 8 wt %.

2. The high-efficiency buoyancy-driven convection based 3D solar evaporator of claim 1, wherein the interconnected porous structure comprises polyurethane, cellulose, alginate, polyvinyl alcohol, polyacrylamide or any mixture thereof.

3. The high-efficiency buoyancy-driven convection based 3D solar evaporator of claim 1, wherein the photothermal material comprises carbon nanotube, carbon black, carbon nanodots, graphene or any mixture thereof.

4. The high-efficiency buoyancy-driven convection based 3D solar evaporator of claim 1, wherein the light absorption of the evaporator is at least 97%.

5. The high-efficiency buoyancy-driven convection based 3D solar evaporator of claim 1, wherein the temperature difference between the high salt zone and the bulk water is less than 8° C.

6. The high-efficiency buoyancy-driven convection based 3D solar evaporator of claim 1, wherein the average size of the macrochannels is approximately 500-1200 μm.

7. The high-efficiency buoyancy-driven convection based 3D solar evaporator of claim 1, wherein the evaporator is capable of absorbing 800 μL water in less than 0.2 s.

8. The high-efficiency buoyancy-driven convection based 3D solar evaporator of claim 1, wherein the evaporator is capable of transporting water to 20 mm height in less than 50 s.

9. A method of making the high-efficiency buoyancy-driven convection based 3D solar evaporator of claim 1, comprising:
providing a first porous matrix;
providing a second photothermal material;
mixing the first porous matrix and second photothermal material to form a third aqueous mixture;
pouring the third aqueous mixture into a 3D printed silicon mold and freeze at a temperature of −70° C. to −90° C.; and
freeze-drying to remove the ice crystals.

10. The method of claim 9, wherein the first porous matrix comprises polyurethane, cellulose, alginate, polyvinyl alcohol, polyacrylamide or a mixture thereof.

11. The method of claim 9, wherein the second photothermal material comprises carbon nanotube, carbon black, carbon nanodots, graphene or a mixture thereof.
